(19) United States
(12) Patent Application Publication
(10) Pub. No.: US 2014/0001307 A1
(43) Pub. Date: Jan. 2, 2014

(54) Aircraft Gearbox Lubrication System

(71) Applicants: Ryan T. Ehinger, Irving, TX (US); Brian S. Vollmer, Grapevine, TX (US)

(72) Inventors: Ryan T. Ehinger, Irving, TX (US); Brian S. Vollmer, Grapevine, TX (US)

(73) Assignee: BELL HELICOPTER TEXTRON INC., FORT WORTH, TX (US)

(21) Appl. No.: 13/538,631

(22) Filed: Jun. 29, 2012

(51) Int. Cl. F16H 57/04; B64C 27/14; C10M 125/02

(52) U.S. Cl. 244/17.11; 508/113; 184/26

(57) ABSTRACT

According to one embodiment, an aircraft gearbox lubrication system includes a lubricant source containing a nanodiamond lubricant, a pump, and a dispenser. The nanodiamond lubricant comprises a base lubricant and a nanodiamond additive. The pump is in fluid communication with the lubricant source and is configured to provide a flow of the lubricant from the lubricant source. The dispenser is in fluid communication with the reservoir and configured to allow the nanodiamond lubricant to flow from the pump onto a component in a gearbox at a predetermined rate.

### TECHNICAL FIELD

This invention relates generally to aircraft gearboxes, and more particularly, to an aircraft gearbox lubrication system.

### BACKGROUND

A helicopter may include one or more rotor systems. One example of a helicopter rotor system is a main rotor system. A main rotor system may generate aerodynamic lift to support the weight of the helicopter in flight and thrust to counteract aerodynamic drag and move the helicopter in forward flight. Another example of a helicopter rotor system is a tail rotor system. A tail rotor system may generate thrust in the same direction as the main rotor system's rotation to counter the torque effect created by the main rotor system. A rotor system may include a gear box that transmits energy from a power source to the rotor blades.

### SUMMARY

Particular embodiments of the present disclosure may provide one or more technical advantages. A technical advantage of one embodiment may include the capability to reduce the weight of a gearbox in an aircraft. A technical advantage of one embodiment may also include the capability to reduce the quantity of lubricant used in an aircraft gearbox. A technical advantage of one embodiment may also include the capability to improve gearbox life. A technical advantage of one embodiment may also include the capability to improve gearbox efficiency and performance.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 shows a helicopter according to one example embodiment;

FIG. 2 shows the power train system of the helicopter of FIG. 1;

FIG. 3 shows a lubrication system operable to lubricate the gearbox of FIG. 2; and

FIG. 4 shows a jet of the lubrication system of FIG. 3 lubricant on a gear tooth of the gearbox of FIG. 2.

### DETAILED DESCRIPTION OF THE DRAWINGS

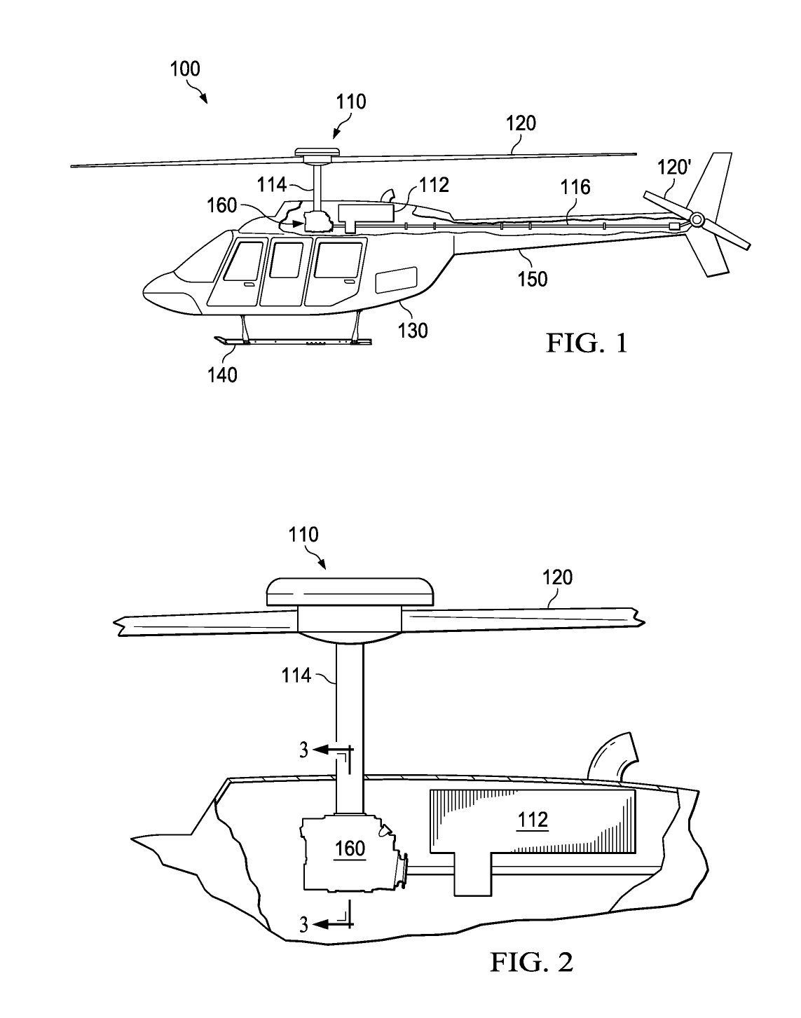

FIG. 1 shows a helicopter 100 according to one example embodiment. Helicopter 100 features power train system 110, main rotor blades 120, tail rotor blades 120′, a fuselage 130, a landing gear 140, and an empennage 150. Power train system 110 may rotate blades 120 and/or blades 120′. FIG. 2 shows the power train system 110 of FIG. 1.

In the example of FIGS. 1 and 2, power train system 100 includes an engine 112, a gearbox 114, a main rotor mast 116, and a tail rotor drive shaft 118. Engine 112 supplies torque to main rotor mast 116 via gearbox 114 for rotating of blades 120. Engine 112 also supplies torque to tail rotor drive shaft 118 for rotating blades 120′. In the example of FIG. 1, gearbox 114 is a main rotor transmission system. Teachings of certain embodiments recognize, however, that power train system 110 may include more or different gearboxes than gearbox 114 shown in FIG. 1. Power train system 110 may include a control system for selectively controlling the pitch of each blade 120 in order to selectively control direction, thrust, and lift of helicopter 100.

Fuselage 130 represents the body of helicopter 100 and may be coupled to power train system 110 such that power train system 110 and blades 120 may move fuselage 130 through the air. Landing gear 140 supports helicopter 100 when helicopter 100 is landing and/or when helicopter 100 is at rest on the ground. Empennage 150 represents the tail section of the aircraft and features blades 120′. Power train system 110 and blades 120′ may collectively provide thrust in the same direction as the rotation of blades 120 so as to counter the torque effect created by blades 120. It should be appreciated that teachings from helicopter 100 may apply to aircraft other than rotorcraft, such as airplanes, tilt rotors, unmanned aircraft, to name a few examples. In addition, teachings of certain embodiments relating to rotor systems described herein may apply to rotor system 110, rotor system 110′, and/or other rotor systems, including but not limited to non-helicopter rotor systems.

As stated above, a gearbox may transmit power from a power source (e.g., engine 112) to an object to be moved. A gearbox may convert speed and torque between the power source and the object to be moved. One example of a gearbox may include a variable-speed transmission. A variable-speed transmission is a gearbox that can be “shifted” to dynamically change the speed-to-torque ratio.

A gearbox may include various gears and bearings. A gear is a rotating machine having teeth that mesh with another toothed part in order to transmit torque. Gears in a gearbox may be used to provide speed and torque conversions. A bearing may include any of various machine elements that constrain the relative motion between two or more parts to only the desired motion. Bearings in a gearbox may perform tasks such as supporting a gear shaft.

Gears, bearings, and other mechanical components of a gearbox are subject to wear and heat generation due to contact with other components. These mechanical components may be lubricated to reduce friction and transfer heat away from the components. Lubrication is the process or technique employed to reduce wear of one or both surfaces in close proximity, and moving relative to each other, by interposing a substance (lubricant) between the surfaces to help carry the load (pressure generated) between the opposing surfaces.

A lubricant is a substance introduced to reduce friction between moving surfaces. Examples of lubricants include oil, biolubricants derived from plants and animals, synthetic oils, solid lubricants, and aqueous lubricants. Example transmission oils for gearbox 114 may include oils meeting specifications MIL-PRF-23699 (5cSt), DOD-L-7808 (3-4cSt), DOD-PRF-85734 (5cSt), and other oils in the 9cSt to 10cSt viscosity range.

Additives may improve performance of base lubricants. For example, teachings of certain embodiments recognize that nanodiamond additives may reduce friction and improve heat transfer performance of some base lubricants. Nanodiamonds may originate from a detonation, such as from detonation of an oxygen-deficient explosive mixture of trinitrotoluene (TNT) and Research Department Explosive (RDX). When TNT and RDX are detonated in a closed chamber, the soot that remains may contain small diamonds (e.g., nominally less than ten nanometers in diameter). Nanodiamonds may have a rounded shape that reduces friction by changing “sliding” friction into “rolling” friction. Reducing friction between opposing surfaces may reduce the amount of heat generated by the interaction of the opposing surfaces.

A nanodiamond additive may be added to an existing lubricant to reduce temperatures in an existing mechanical device (e.g., a gearbox). Nanodiamonds may increase the conductivity of the base lubricant while having a somewhat neutral impact on the heat capacity relative to conductivity, thus allowing the fluid to transfer heat more efficiently. In some circumstances, nanodiamond additives may reduce friction by thirty to fifty percent and may improve heat conductivity by twelve percent.

In high-temperature environments, such as a truck or train engine, nanodiamond additives may be added to lubricant in an existing engine to improve engine performance. Of course, nanodiamond additives increase lubrication costs; thus, nanodiamond additives would normally not be used where wear and efficiency is not a critical design criteria.

Teachings of certain embodiments recognize, however, the ability to build smaller and lighter mechanical devices to take advantage of the improved friction and heat-transfer properties of nanodiamond additives. In the aerospace industry, weight may be an important design criterion. Teachings of certain embodiments recognize that a lubrication system may achieve the same heat-reduction goals while using less volume of lubricant by adding nanodiamond additives to a lubricant. Reducing the volume of lubricant can result in a significant weight savings because the aircraft can carry less lubricant. In addition, aircraft designers can reduce the size of various lubrication system components (e.g., pump, sump, filter, cooler) because the lubrication system components have a smaller workload due to the reduced volume of lubricant.

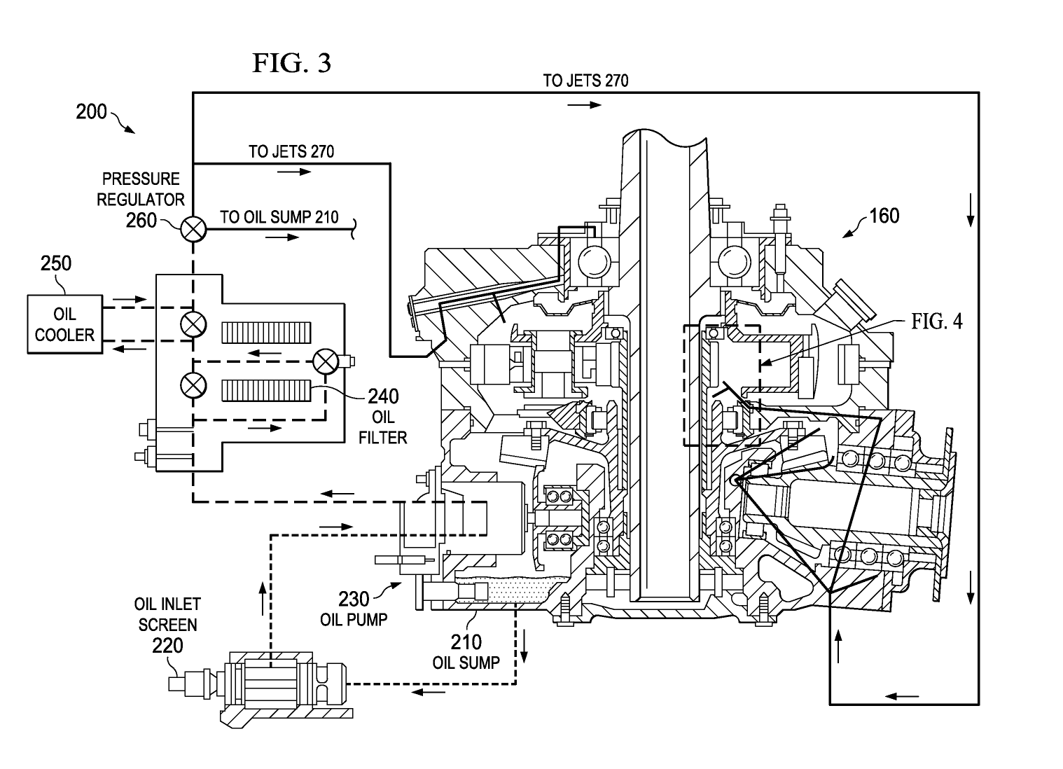

FIG. 3 shows a lubrication system 200 according to one example embodiment. Lubrication system 200 features a lubricant sump 210, a lubricant inlet screen 220, a pump 230, a filter 240, a lubricant cooler 250, a pressure regulator 260, and jets 270. Other embodiments of lubrication system 200 may contain more, fewer, or different components. Embodiments of lubrication system 200 may be pressurized or unpressurized. For example, jets 270 may dispense either pressurized or unpressurized lubricant on a part.

Lubricant sump 210 is a reservoir that stores lubricant within lubrication system 200. Sump 210 may be integral with the housing of gearbox 160 (as shown in FIG. 3) or separate from the housing of gearbox 160. Lubricant inlet screen 220 is a filter that prevents removes the largest particulates from the lubricant. Pump 230 circulates lubricant under pressure throughout lubrication system 200. Filter 240 removes some contaminants from the lubricant. Lubricant cooler 250 lowers the temperature of the lubricant before the lubricant is applied to the various components that generate heat. Pressure regulator 260 measures the lubricant pressure within lubrication system 200 and diverts excess lubricant back to lubricant sump 210 if the lubricant pressure is too high. Jets 270 dispense lubricant on components of gearbox 160 that are subject to friction and/or generate heat, such as gears and bearings.

Lubricant in lubrication system 200 may include a nanodiamond additive, as described above. The amount of nanodiamond additive in the lubricant may vary in different embodiments. As more nanodiamond additive is added to the lubricant, thermal conductivity may increase, but cost and viscosity also may increase. Teachings of certain embodiments recognize that the negative attributes of having excess nanodiamond additive may be limited if the nanodiamond additive is between 0.005 and 0.3 percent of the weight of the nanodiamond lubricant.

Teachings of certain embodiments recognize that lubrication system 200 may decrease the amount of lubricant used if the lubricant includes nanodiamond additive. For example, if nanodiamonds decrease friction by thirty to fifty percent, lubrication system 200 may use thirty to fifty percent less lubricant to remove the required heat. For example, jets 270 may dispense thirty to fifty percent less lubricant on a gear or bearing if the lubricant contains a nanodiamond additive.

By decreasing the amount of lubricant used in lubrication system 200, the sizes of sump 210, pump 230, filter 240, cooler 250, and jets 270 may also be reduced. For example, sump 210 may be smaller to hold less lubricant, and pump 230 may be smaller because it has less lubricant to pressurize and/or move. Thus, teachings of certain embodiments recognize the ability to reduce the weight of lubrication system 200 by reducing both the volume of lubricant used and by reducing the physical components within lubrication system 200 that process the lubricant. For example, in some embodiments, reducing the volume of lubricant may save four to seven pounds on smaller aircraft and eleven to seventeen pounds on larger aircraft.

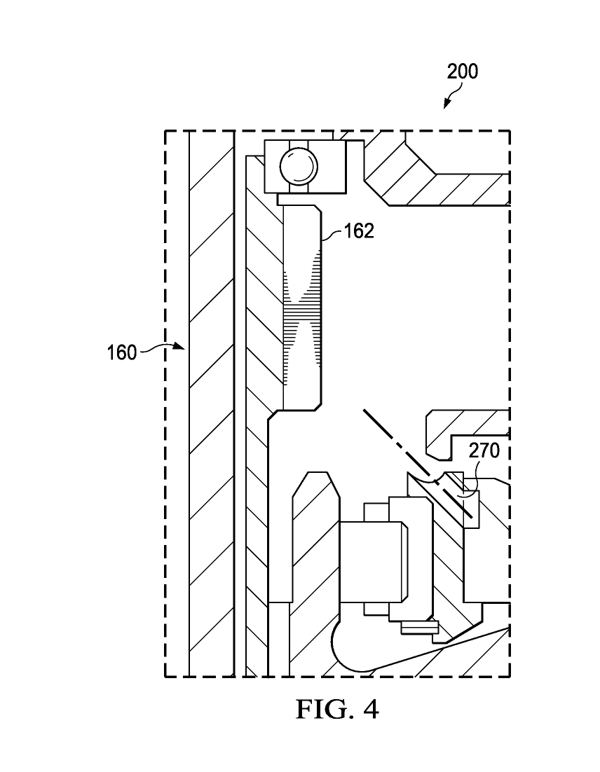

FIG. 4 shows a jet of lubrication system 200 dispensing nanodiamond lubricant on a gear tooth of gearbox 160. As shown in FIG. 4, jet 270 dispenses nanodiamond lubricant on gear tooth 162. Teachings of certain embodiments recognize that jet 270 may dispense less lubricant if the lubricant contains a nanodiamond additive. In addition, teachings of certain embodiments recognize that gear tooth 162 may be configured to transmit more power and operate under a higher scoring temperature limit because nanodiamond lubricant may transfer heat away from gear tooth 162 more effectively than a base lubricant without a nanodiamond additive.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. An aircraft, comprising:
a fuselage;
one or more rotor blades; and
a drive train coupled to the fuselage and operable to rotate the one or more rotor blades, the drive train comprising:
a lubricant source containing a nanodiamond lubricant, the nanodiamond lubricant comprising a base lubricant and a nanodiamond additive;
a pump in fluid communication with the lubricant source and configured to provide a flow of the lubricant from the lubricant source; and
a dispenser in fluid communication with the reservoir and configured to allow the nanodiamond lubricant to flow from the pump onto a component in a gearbox at a predetermined rate.

2. The aircraft of claim 1, wherein the nanodiamond additive is between 0.005 and 0.3 percent of the weight of the nanodiamond lubricant.

3. The aircraft of claim 1, wherein the gearbox is a transmission.

4. The aircraft of claim 1, wherein the component is a bearing.

5. The aircraft of claim 1, wherein the component is a gear.

6. The aircraft of claim 1, wherein the base lubricant is oil.

7. The aircraft of claim 1, wherein the lubricant source is a fluid housing integral with a gearbox housing.

8. The aircraft of claim 1, wherein the lubricant source is a separate fluid housing attached to a gearbox housing.

9. An aircraft gearbox lubrication system comprising:
a lubricant source containing a nanodiamond lubricant, the nanodiamond lubricant comprising a base lubricant and a nanodiamond additive;
a pump in fluid communication with the lubricant source and configured to provide a flow of the lubricant from the lubricant source; and
a dispenser in fluid communication with the reservoir and configured to allow the nanodiamond lubricant to flow from the pump onto a component in a gearbox at a predetermined rate.

10. The gearbox lubrication system of claim 9, wherein the nanodiamond additive is between 0.005 and 0.3 percent of the weight of the nanodiamond lubricant.

11. The gearbox lubrication system of claim 9, wherein the gearbox is a transmission.

12. The gearbox lubrication system of claim 9, wherein the component is a bearing.

13. The gearbox lubrication system of claim 9, wherein the component is a gear.

14. The gearbox lubrication system of claim 9, wherein the base lubricant is oil.

15. The gearbox lubrication system of claim 9, wherein the lubricant source is a fluid housing integral with a gearbox housing.

16. The gearbox lubrication system of claim 9, wherein the lubricant source is a separate fluid housing attached to a gearbox housing.

17. A method of lubricating an aircraft gearbox, comprising:
storing a nanodiamond lubricant, the nanodiamond lubricant comprising a base lubricant and a nanodiamond additive;
pressurizing the nanodiamond lubricant to yield a pressurized flow of the lubricant; and
dispensing the pressurized flow of the lubricant towards a component in a gearbox at a predetermined rate.

18. The method of claim 17, wherein the nanodiamond additive is between 0.005 and 0.3 percent of the weight of the nanodiamond lubricant.

19. The method of claim 17, 12. wherein the component is a bearing or a gear.

20. The method of claim 17, wherein the base lubricant is oil.
